(19) United States
(12) Patent Application Publication
(10) Pub. No.: US 2021/0094225 A1
(43) Pub. Date: Apr. 1, 2021

(54) ADDITIVE MANUFACTURING PRESSURE DEVICE, PROCESS AND OBTAINED PARTS THEREOF

(71) Applicant: Braskem America, Inc., Pittsburgh, PA (US)

(72) Inventors: Alessandro Bernardi, Pittsburgh, PA (US); Marcos Roberto Paulino Bueno, Sao Paulo - SP (BR)

(73) Assignee: Braskem America, Inc., Pittsburgh, PA (US)

(21) Appl. No.: 16/954,816

(22) PCT Filed: Dec. 19, 2018
(86) PCT No.: PCT/US2018/066503

§ 371 Date: Jun. 17, 2020

Related U.S. Application Data
(60) Provisional application No. 62/608,957, filed on Dec. 21, 2017.

(51) Int. Cl. B29C 64/153; B29C 64/255; B33Y 10/00; B33Y 30/00

(52) U.S. Cl. CPC B29C 64/153; B29C 64/255; B29K 2023/0683; B33Y 30/00; B33Y 10/00

(57) ABSTRACT

A laser sintering device for producing parts composed of powder materials is disclosed, the device including a mechanism which allows for porosity control during production of parts made with the materials. A method of producing a three-dimensional object is also provided, which includes the steps of disposing a layer of a powder material on a target surface, applying pressure to a powder material layer and directing an energy beam over a selected area of the powder material layer, wherein the powder is sintered or melted, and repeating the steps to form the three-dimensional object. The resultant three-dimensional objects made of powder material are also described.

### CROSS-REFERENCE TO RELATED APPLICATIONS

The present application claims benefit of U.S. Provisional Patent Application No. 62/608,957, filed on Dec. 21, 2017, the entirety of which is incorporated herein by reference.

### FIELD OF THE INVENTION

The present invention relates to a device to add pressure in a laser sintering process. The present invention further relates to the production process of a part made of e.g., ultra-high molecular weight polyethylene with a different porosity index and the part therefore produced.

### BACKGROUND OF THE INVENTION

Parts made of ultra-high molecular weight polyethylene (UHMWPE) have a high commercial value due to their special properties such as low density, chemical resistance, very high toughness, impact resistance, excellent wear resistance and low coefficient of friction, along with a relatively low price. On the other hand, the costs involved in UHMWPE processing are still high, because this polymer does not flow. In order to overcome this characteristic, sintering methods have been used, such as thermo-compression processes and ram extrusion processing. However, those processes result in a large block or conceptually infinite dowels and profiles. Nevertheless, when a more complex part is needed, a post-machining step will be necessary. In those processes, a solid and non-porous part is obtained due to the presence of heat and pressure.

UHMWPE does not flow due to its very high molecular weight. In the melted state, UHMWPE molecules have a very high entanglement level, resulting in a high viscosity, hindering the processability in the ordinary processing methods widely used in thermoplastics. However, when a sintering method is used, heat, pressure and time are necessary for producing a solid part having good mechanical properties.

In general, UHMWPE is sold in powder form. UHMWPE particles are highly porous and thus need heat and pressure to achieve enough molecular mobility and interfacial contact so that the reptation process may take place. The reptation model was originally developed by P. G. de Gennes (1971) and explains that a polymeric molecule in the melted state diffuses into an imaginary tube until a thermodynamically entangled state is achieved. The reptation theory is used to understand the sintering behavior of UHMWPE particles at temperatures greater than the melting point and at high pressure. In this process, high pressure is needed to ensure that no voids from the porosity remain in the final part, allowing a highly interfacial contact so that the reptation process can occur. In this process, molecules from different particles pass through the interfacial surface, making a well-linked interface.

UHMWPE is a semi-crystalline polymer that melts similarly to ordinary polyethylene. In a DSC (differential scanning calorimetry) experiment, nascent UHMWPE powder has a first melting point in a temperature range between from 140° C. to 146° C., whereas in the second fusion, the melting point range is from 132° C. to 135° C. This observed decrease in melting point in the second compared to the first melting event can be explained by a lower entangled level of UHMWPE molecules when crystalized in catalyst sites during synthesis. In a sintering process, the diffusion mechanism between interface walls is possible just above the melting point, because crystals work as anchoring sites, hindering the reptation phenomenon.

The nascent UHMWPE is a very porous particle. Even in a melted state, pressure is necessary to collapse the porous particle, and therefore allow close contact among interfaces. Thus, a temperature greater than the melting point and pressure are necessary to reduce the porosity in the final part. The minimum pressure needed to produce acceptable parts depends on molecular weight. The typical pressure range used to produce acceptable parts ranges from 5 to 30 MPa. ISO Standard recommends a pressure of 10 MPa in a full pressure step, so that specimens can be repeatedly obtained.

Besides heating and pressure, time is the third key aspect in UHMWPE molding. The higher the molecular weight, the lower will be the molecular diffusion velocity in a sintering process. Time is therefore an important cost component in the UHMWPE molding operation. Technical knowledge in this industry is achieved by mastering those three processing parameters: temperature, pressure and time.

There are two main processes to sinter UHMWPE and thus produce acceptable parts. The first is thermal compression, where in general a large block is produced. The final parts having different geometries are obtained using the general machining methods commonly used in metals. This processing can be considered as batch processing, and is work and time intensive. The time spent is in part due to a very slow reptation process and in part due to a very low heating conductivity of UHMWPE. The time required for a plate core to achieve the desired temperature, passing by a very thick path, is quite high.

The second sintering process commonly used is ram extrusion. In this method, a conceptually infinite profile having different cross-sectional geometries is obtained. The powder is fed in a piston cavity. Ram or plunger extruders are simple in design, having an essentially positive displacement, being able to generate very high pressures. In their intermittent operation, the polymer is rammed in the die direction while it is molded. Due to the back pressure generated by high polymeric viscosity, the pressure achieved can reach 300 MPa in this kind of extruder. Ram extrusion can be considered as a semi-continuous process to sinter UHMWPE.

Additive manufacturing is the official term used to describe the process to produce parts layer-by-layer using a similar concept used in printers. However, in additive manufacturing, a volume element is added instead. In this process, these volume units are commonly called voxels.

In additive manufacturing, the voxels are added layer-by-layer to form a final three-dimensional (3D) piece, and for this reason the term 3D printing became commonplace. An advantage of this process is the possibility of obtaining very complex geometries which are difficult to be made through the ordinary molding process.

3D printing was invented almost 50 years ago, and the first commercial system was commercially available in the late 1980s. In this process, seven process categories were developed: 1. Material extrusion, 2. Material Jetting, 3. Binder Jetting, 4. Sheet Lamination, 5. Vat Photopolymerization, 6. Powder Bed Fusion and 7. Directed Energy Deposition.

Due to UHMWPE characteristics, Powder Bed Fusion is very promising, because no flow is necessary in this process. Powder Bed Fusion, where 3D laser sintering is by far the most popular method, uses a highly energetic beam to melt a specific region of the surface of polymeric powder. In this method, there are four key components: a laser scanning system, a powder delivery system, a roller or rake and a fabricated piston, as shown in FIG. 1. The following identifiers are associated with this figure:
1—Powder bed.
2—Powder reservoir.
3—Powder delivery piston.
4—Fabrication piston.
5—Scanner.
6—Laser beam.
7—Laser source.
8—Roller, rake.
9—3D part.
10—Powder collector container.

In the first step, the powder reservoir (2) is full while the powder bed (1) is empty. The powder delivery piston (3) is moved up one layer and then the roller (8) passes, dragging the powder to fill the first layer in the powder bed (1). At that moment, the laser source (7) is switched on and the scanner (5) starts to melt a 2D surface in a powder bed (9), moving the laser beam (6) in a pre-defined path. At the end of this step, a new step begins with a concomitant opposite layer movement with both a powder delivery piston (3) and a fabrication piston (4). A new fresh powder layer is charged over the powder bed, and the process starts again. The part is made, layer-by-layer until the powder reservoir becomes empty. The part can then be finished. The powder in excess accumulates in the reservoir (10).

Additive manufacturing processes have opened a new range of possibilities in generating parts with very complex geometries using UHMWPE, previously not possible using classic processing methods. Additive manufacturing allows producing new part geometries with unique UHMWPE properties, what can be very valuable for many different applications.

The ordinary additive manufacturing process, more specifically the laser sintering process, can be used for producing parts using UHMWPE. However, due to the fact that UHMWPE does not flow under heating conditions, the final parts produced are highly porous. That porosity decreases the mechanical properties of UHMWPE, resulting in a poor final part.

Thus, producing parts made of UHMWPE using an additive manufacturing method remains a challenge.

### SUMMARY OF THE INVENTION

The present invention relates to a device able to apply pressure during laser sintering.

The present invention further relates to the process to produce that part with a different degree of porosity and therefore different mechanical property levels.

The present invention further relates to parts made of e.g., UHMWPE using laser sintering with controllable pressure levels, in this way being able to produce parts with different porosity levels, not obtainable using an ordinary laser sintering method.

### BRIEF DESCRIPTION OF THE DRAWINGS

The present invention is best understood from the following detailed description when read in conjunction with the accompanying drawings. It is emphasized that, according to common practice, the various features of the drawings are not necessarily to scale. On the contrary, the dimensions of the various features are arbitrarily expanded or reduced for clarity. Like reference numerals denote like features throughout specification and drawings.

FIG. 1 illustrates four key components of Powder Bed Fusion, i.e., a laser scanning system, a powder delivery system, a roller or rake and a fabricated piston.

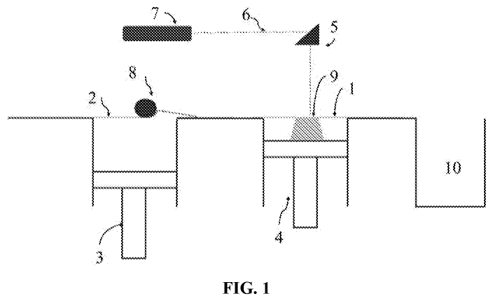

FIG. 2 illustrates an exemplary device comprising a movable closing cap (11) that works as a bulkhead (anteparo, in Portuguese).

FIG. 3 illustrates an exemplary bulkhead which can be comprised of a non-transparent material.

### DETAILED DESCRIPTION OF THE INVENTION

The present invention relates to a device able to apply pressure during the laser sintering process. The device introduces pressure in an ordinary sintering process, allowing for porosity control during production of parts made with UHMWPE.

Unlike temperature and time, pressure is the single key parameter important to produce solid parts of UHMWPE, that is not present in an ordinary laser sintering process.

Pressure is necessary for collapsing voids and allowing enough contact among porosity interfaces, important considerations for achieving reptation.

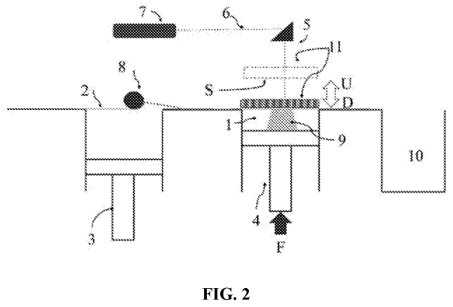

FIG. 2 illustrates the device comprising a movable closing cap (11) that works as a bulkhead (anteparo, in Portuguese). The bulkhead is comprised of any mechanically resistant material able to bear pressure and also be transparent to a laser beam (6). The bulkhead is moved by any motorized device able to position it in up (U) and down (D) positions.

In an embodiment of the present invention, the bulkhead is comprised of any material transparent to a laser beam such as, but not limited to, germanium (Ge), zinc selenite (ZnSe), gallium arsenide (GaAs), or any material transparent to a CO₂ laser beam.

In further embodiments of the present invention, other materials can be used depending on the type of laser used.

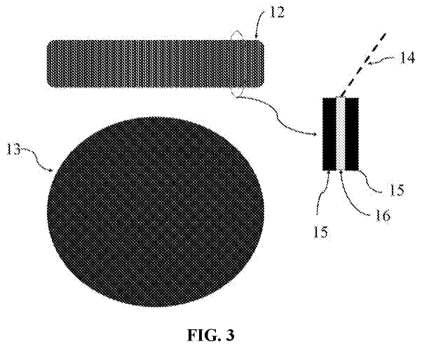

In an additional embodiment of the present invention, the bulkhead can be comprised of a non-transparent material as shown in FIG. 3. The following identifiers are associated with this figure:
12—Non transparent bulkhead cap (lateral view).
13—Non transparent bulkhead cap (superior view).
14—Laser beam.
15—Insulating material.
16—Oriented thermal conductor

In this embodiment, the bulkhead is composed of a mechanically resistant and insulating material (15), containing an isotropic heating conductor (16). In this exemplary device, the laser shines each conductor point (14) in the bulkhead's top surface (12). In this way, heat will propagate along the isotropic conductor (16) to the bulkhead's bottom surface, heating a very restricted region of powder under pressure. This device was developed as an option to a transparent bulkhead. CO₂ transparent materials are in general brittle and/or expensive.

In a further embodiment of present invention, the isotropic heating conductor (16) can be any oriented material having a high thermal conductivity in its main axis direction. Examples of oriented materials include, but are not limited to, carbon fiber, metal filament, graphite fiber, etc.

In a further embodiment of present invention, the insulating material (15) can be any mechanically resistant and insulating material such as, but not limited to an epoxy resin.

In order to apply pressure over the top of the powder bed (1), the bulkhead (11) is fixed in the D position by means of a clamp (not shown) to bear pressure imposed by a fabrication piston (4). The fabrication piston (4) is moved by any suitable driver such as a servo-hydraulic system, electro-fuse system, etc. The pressure is set according to the following Equation 1.

P=F/S Equation 1

### Where:

P is the pressure, in MPa.
F (FIG. 2) is the force, in N.
S (FIG. 2) is the surface in m².

In an additional embodiment of the present invention, the process to produce parts made of UHMWPE is described by the following steps:
a) In the first step, the powder reservoir (2) is completely filled with UHMWPE powder and the powder bed (1) is empty. The fabrication piston is at the upper position and the bulkhead is at the U position;
b) Then, the powder delivery piston is moved one layer up while the fabrication piston is lowered one layer;
c) The roller (8) pushes the powder layer from the powder reservoir (2), spreading it over the powder bed (1);
d) The bulkhead goes to the D position and is fixed in this position by mean of a clamp;
e) The fabrication piston applies a pre-defined force F on the powder layer;
f) A specific time is allotted for the compressive force to produce a cold sintering;
g) The laser (7) is switched on and the scanner directs the laser beam on the pre-defined surface of the pressurized powder bed;
h) A specific time is allotted for the compressive force to produce a hot sintering;
i) The laser is switched off and a specific time is set, so that the layer can be cooled;
j) The bulkhead is moved to the U position;
k) The roller (8) goes to the home position; and
l) The steps from b to k are repeated until the part (9) is finished.

The present invention describes a part produced for any powder that can be sintered, such as metals, ceramics, vitreous materials, polymeric materials, and combinations thereof.

In a preferred embodiment, any polymeric powder can be used, such as polyolefins, polyvinyl chloride (PVC), polytetrafluoroethylene (PTFE), UHMWPE, and combinations thereof.

In a particularly preferred embodiment, an UHMWPE is used.

The present invention further relates to a part made of UHMWPE that is produced by laser sintering under different pressure levels. The pressure will define the amount of porosity of the final part.

In a further embodiment of the present invention, a pressure range from 0 to 300 MPa is desirable, with a range of 5 to 80 MPa preferred, and a range from 5 to 30 MPa particularly preferred.

In an additional embodiment of the present invention, the Porosity Index (PI), according to the following Equation 2, defines the level of part porosity:

$$PI = \frac{{ρ}_{part}}{{ρ}_{pol}} \qquad Equation 2$$

Where:
PI is the porosity index. ρₚₐᵣₜ is the density of a part produced by the process described in the present invention, in kg/m³ at room temperature (23° C.).
ρₚₒₗ is the density of polymer, in kg/m³ at room temperature (23° C.).

The effect of pressure on the mechanical and tribological properties of UHMWPE has been previously studied. The mechanical and tribological properties increase asymptotically with applied pressure. The pressure is necessary to keep the porous wall in contact, allowing the reptation process to occur.

In an additional embodiment of the present invention, a part made of UHMWPE has a porosity index (PI) from 0 to 1, with a porosity index from 0.3 to 1 preferred, and a porosity index from 0.6 to 1 particularly preferred.

The present invention further relates to a method of producing a three-dimensional object comprising the steps of: (a) disposing a layer of a powder material on a target surface; (b) applying pressure to the powder material layer; (c) directing an energy beam over a selected area of the powder material layer, wherein the powder is sintered or melted; and (d) repeating steps (a)-(c) to form the three-dimensional object. This method may further comprise the step of disposing a bulkhead over the powder material after disposing the layer of the powder material on a target surface. Step (c) may occur under pressure, steps (b) and (c) may occur sequentially, and the bulkhead may be transparent to the energy beam.

The foregoing is provided for purposes of illustrating, explaining, and describing embodiments of this invention. Modifications and adaptations to these embodiments will be apparent to those skilled in the art and may be made without departing from the scope or spirit of this invention.

Although the subject matter has been described in terms of exemplary embodiments, it is not limited thereto. Rather, the appended claims should be construed broadly, to include other variants and embodiments, which may be made by those skilled in the art.

What is claimed is:

1. A laser sintering device for producing parts comprised of powder materials, wherein said device comprises a mechanism which allows for porosity control during production of parts made with said materials.

2. The device as recited in claim 1, wherein said materials are selected from the group consisting of metals, ceramics, vitreous materials, polymeric materials and combinations thereof.

3. The device as recited in claim 1, wherein said materials are selected from the group consisting of polyolefins, polyvinyl chloride, polytetrafluoroethylene, ultra-high molecular weight polyethylene and combinations thereof.

4. The device as recited in claim 1, wherein the powder material comprises ultra-high molecular weight polyethylene.

5. The device as recited in claim 1, wherein said device includes a movable closing cap which works as a bulkhead.

6. The device as recited in claim 5, wherein said bulkhead is comprised of a mechanically resistant material able to bear pressure.

7. The device as recited in claim 5, wherein said bulkhead is transparent to a laser beam.

8. The device as recited in claim 1, wherein said mechanism applies pressure during laser sintering.

9. The device as recited in claim 8, wherein the pressure is from about 0 to 300 MPa.

10. The device as recited in claim 9, wherein the pressure is from about 5 to 80 MPa.

11. The device as recited in claim 10, wherein the pressure is from about 5 to 30 MPa.

12. The device as recited in claim 5, wherein said bulkhead is comprised of a material transparent to a laser beam.

13. The device as recited in claim 5, wherein said bulkhead is comprised of a material selected from the group consisting of germanium, zinc selenite and gallium arsenide.

14. The device as recited in claim 4, wherein parts made of ultra-high molecular weight polyethylene have a porosity index of from about 0 to 1.

15. The device as recited in claim 14, wherein parts made of ultra-high molecular weight polyethylene have a porosity index of from about 0.3 to 1.

16. The device as recited in claim 15, wherein parts made of ultra-high molecular weight polyethylene have a porosity index of from about 0.6 to 1.

17. The device as recited in claim 5, wherein the bulkhead comprises an insulating material containing an isotropic heating conductor.

18. The device as recited in claim 17, wherein said insulating material is an epoxy resin.

19. A method of producing a three-dimensional object comprising the steps of:
(a) disposing a layer of a powder material on a target surface;
(b) applying pressure to the powder material layer;
(c) directing an energy beam over a selected area of the powder material layer, wherein the powder is sintered or melted; and
(d) repeating said steps (a)-(c) to form the three-dimensional object.

20. The method as recited in claim 19, further comprising the step of disposing a bulkhead over the powder material after disposing the layer of the powder material on the target surface.

21. The method as recited in claim 19, wherein step (c) occurs under pressure.

22. The method as recited in claim 19, wherein steps (b) and (c) occur sequentially.

23. The method as recited in claim 20, wherein said bulkhead is transparent to the energy beam.

24. The method as recited in claim 20, wherein said bulkhead is comprised of a material transparent to a laser beam.

25. The method as recited in claim 20, wherein said bulkhead is comprised of a material selected from the group consisting of germanium, zinc selenite and gallium arsenide.

26. The method as recited in claim 20, wherein the bulkhead comprises an insulating material containing an isotropic heating conductor.

27. The method as recited in claim 26, wherein said insulating material is an epoxy resin.

28. The method as recited in claim 19, wherein said powder material is selected from the group consisting of metals, ceramics, vitreous materials, polymeric materials and combinations thereof.

29. The method as recited in claim 19, wherein said powder material is a polymeric material selected from the group consisting of polyolefins, polyvinyl chloride, polytetrafluoroethylene, ultra-high molecular weight polyethylene and combinations thereof.

30. The method as recited in claim 19, wherein said powder material comprises ultra-high molecular weight polyethylene.

31. The method as recited in claim 19, wherein the pressure is from about 0 to 300 MPa.

32. The method as recited in claim 31, wherein the pressure is from about 5 to 80 MPa.

33. The method as recited in claim 32, wherein the pressure is from about 5 to 30 MPa.

34. A three-dimensional object comprised of powder material having a porosity index of from about 0 to 1.

35. The three-dimensional object as recited in claim 34, wherein the object has a porosity index of from about 0.3 to 1.

36. The three-dimensional object as recited in claim 35, wherein the object has a porosity index of from about 0.6 to 1.

37. The three-dimensional object as recited in claim 34, wherein said powder material is selected from the group consisting of metals, ceramics, vitreous materials, polymeric materials and combinations thereof.

38. The three-dimensional object as recited in claim 34, wherein said powder material is a polymeric material selected from the group consisting of polyolefins, polyvinyl chloride, polytetrafluoroethylene, ultra-high molecular weight polyethylene and combinations thereof.

39. The three-dimensional object as recited in claim 34, wherein said powder material comprises ultra-high molecular weight polyethylene.

40. The three-dimensional object as recited in claim 34, prepared by a selective laser sintering process.
